(19) United States
(12) Patent Application Publication
(10) Pub. No.: US 2014/0001118 A1
(43) Pub. Date: Jan. 2, 2014

(54) FILTER CARTRIDGE STRUCTURE

(71) Applicant: XIAMEN RUNNER INDUSTRIAL CORPORATION, Xiamen (CN)

(72) Inventors: Guo-bo Zhou, Xiamen (CN); Zhi-ming Li, Xiamen (CN); Hui-liang Guo, Xiamen (CN)

(73) Assignee: XIAMEN RUNNER INDUSTRIAL CORPORATION, Xiamen (CN)

(21) Appl. No.: 13/763,503

(22) Filed: Feb. 8, 2013

(30) Foreign Application Priority Data
Jul. 2, 2012 (CN) 201220314827.6

(51) Int. Cl. B01D 35/34

(52) U.S. Cl. CPC B01D 35/34
USPC 210/541

(57) ABSTRACT

A filter cartridge structure with a filter cartridge includes a column-shaped main body having an open top, a cavity formed at the middle of the main body and interconnected to the open top, and a joint portion formed at the open top of the main body and combined with an insert. The insert is made of metal, ABS, or any material with physical properties similar to those of ABS to achieve the effects of enhancing the tenacity and impact resisting strength of the joint portion of the filter cartridge effectively, overcoming the problem of the joint portion of the conventional filter cartridge that may be cracked or broken easily, and improving the service life of the filter product.

### BACKGROUND OF THE INVENTION

1. Field of the invention

The present invention relates to a filter, and more particularly to a filter cartridge structure of a filter.

2. Description of Related Art

At present, a filter using a transparent filter cartridge is available in the market to facilitate users to visually observe the using status of a filter core of the filter cartridge of the filter. In general, the transparent filter cartridge is made of PS, PC, PMMA or PET, and materials of this sort come with a low tenacity, so that stress cracks may occur at stress points of a point portion that connects the top of the filter cartridge and a filter cover during the use of the filter. Even a small crack may burst the filter cartridge quickly (as shown in FIG. 1) and affect the service life of the filter product, so that some manufacturers overcome this problem by increasing the thickness of the wall of the filter cartridge. However, such solution not only increases the manufacturing cost of the product, but also fails to achieve the expected effects. Therefore, it becomes an important subject for related manufacturers and designers to overcome the problems of having poor strength and tenacity of the conventional transparent filter cartridge that may be cracked or broken easily.

### SUMMARY OF THE INVENTION

It is a primary objective of the present invention to provide a filter cartridge structure capable of overcoming the issue related to the poor strength and tenacity of the conventional transparent filter cartridge that may be cracked or broken easily.

To achieve the aforementioned objective, the present invention provides a filter cartridge structure with a filter cartridge, comprising a column-shaped main body having an open top, a cavity formed at the middle of the main body and interconnected to the open top, and a joint portion formed at the open top of the main body and combined with an insert. The main body of the filter cartridge is integrally formed and made of AS, and the insert is made of metal, ABS, or any material with physical properties similar to those of ABS.

The insert is embedded into an inner side of the joint portion of the main body, and an internal thread is formed on an inner wall of the insert.

The insert is wrapped into the joint portion of the main body, and an internal thread is formed on an inner wall of the joint portion.

The insert has a through hole formed on a peripheral wall of the insert.

The insert has a rib formed on a peripheral wall of the insert.

With the aforementioned solution, the present invention can achieve the following effects:

1. The main body of the filter cartridge of the present invention is made of AS. Since this material comes with a low tenacity and may be cracked or broken easily, the tenacity becomes better after the inserts are added, so as to enhance the tenacity and impact resisting strength of the joint portion of the filter cartridge joint portion and overcome the fragility issue of the joint point of the conventional filter cartridge joint portion, so as to extend the service life of the filter product.

2. The joint portion of the filter cartridge of the present invention combined with an insert of a better tenacity can reduce the thickness of the wall of the filter cartridge and overcome the stress problem of the thick wall of products formed by plastic injection molding.

### BRIEF DESCRIPTION OF THE DRAWINGS

The invention, as well as its many advantages, may be further understood by the following detailed description and drawings in which:

The invention, as well as its many advantages, may be further understood by the following detailed description and drawings in which:

FIG. 1 shows a conventional filter cartridge structure;

FIGS. 2 and 2A are an exploded view and a cross-sectional view of a filter cartridge structure of the present invention;

FIGS. 3 and 3A are an exploded view and a cross-sectional view of another filter cartridge structure of the present invention; and

FIG. 4 is a schematic view of an insert of another filter cartridge structure of the present invention.

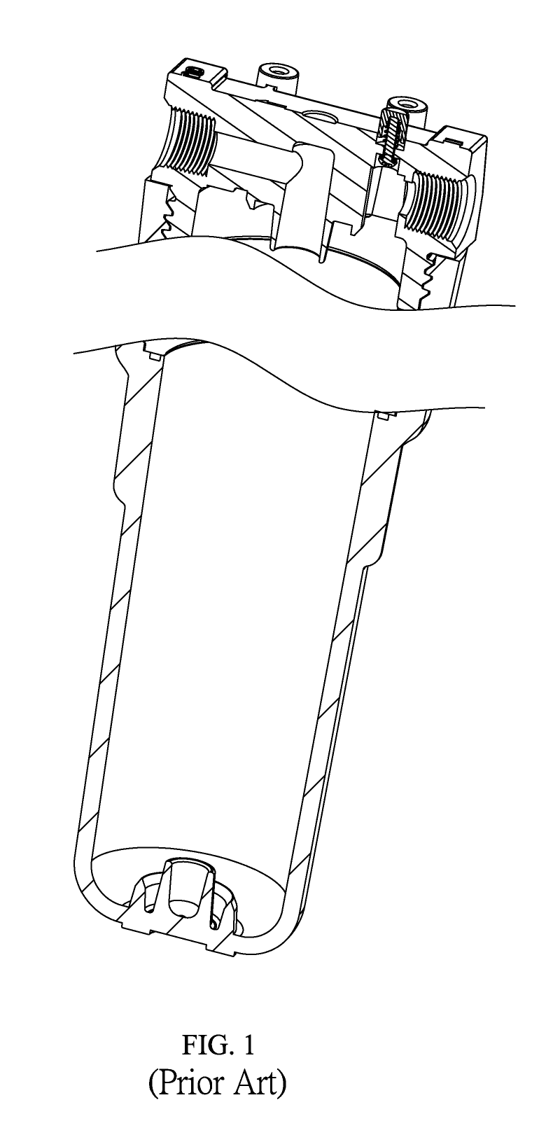

### DETAILED DESCRIPTION OF THE INVENTION

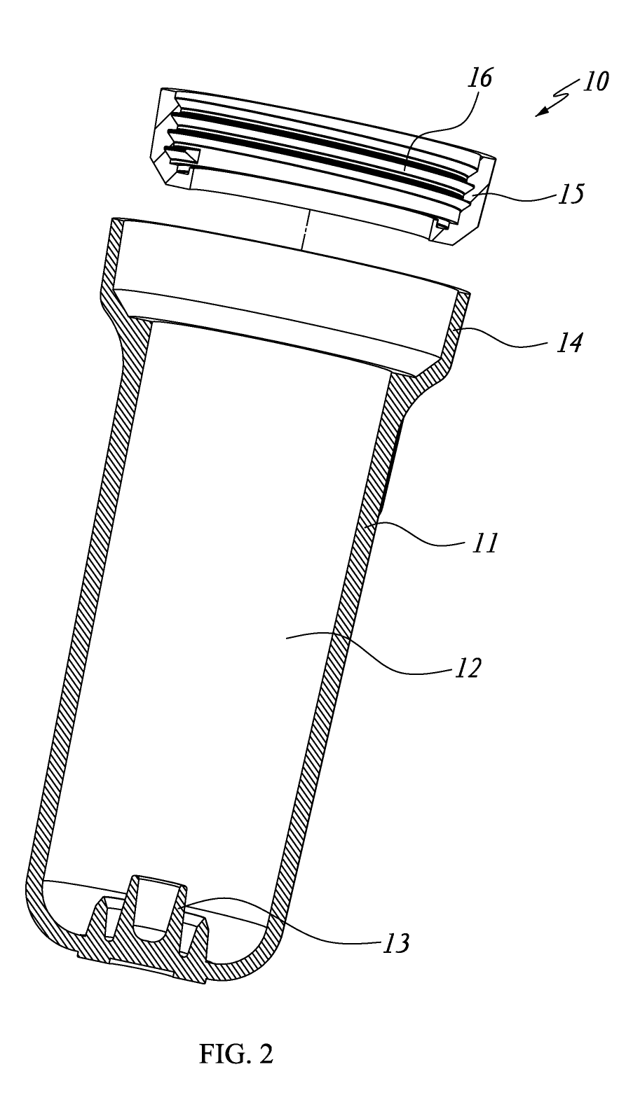

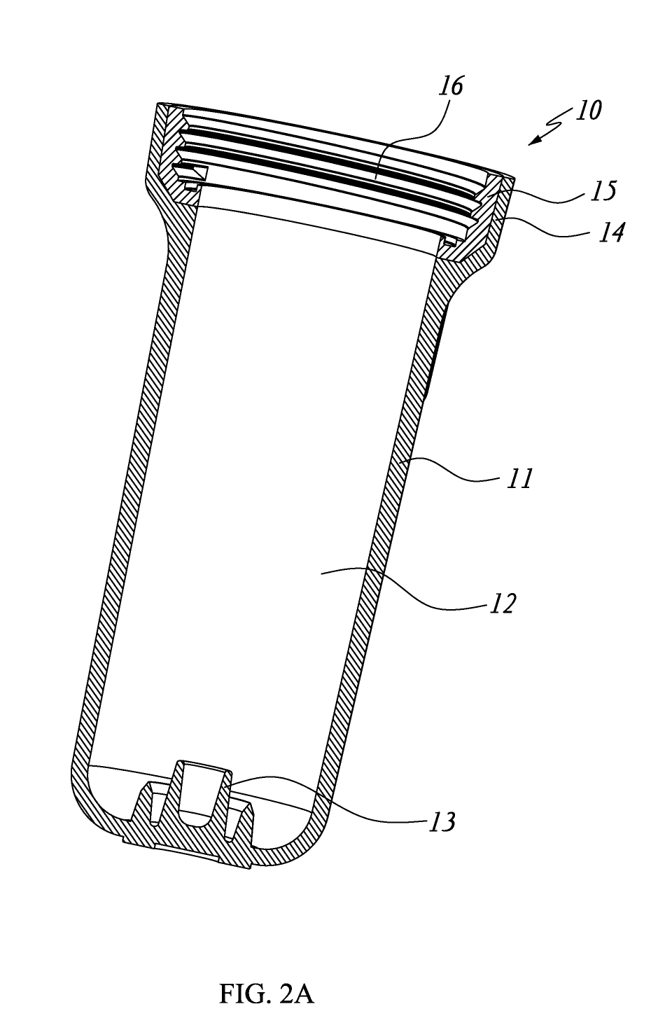

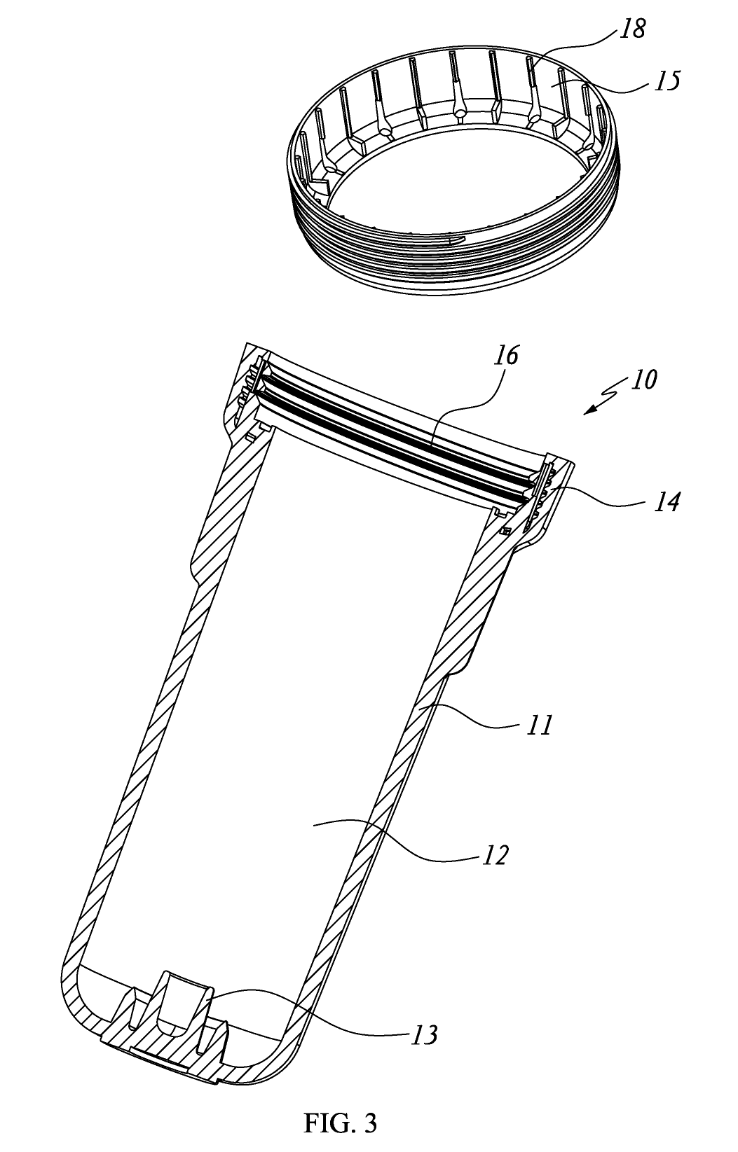

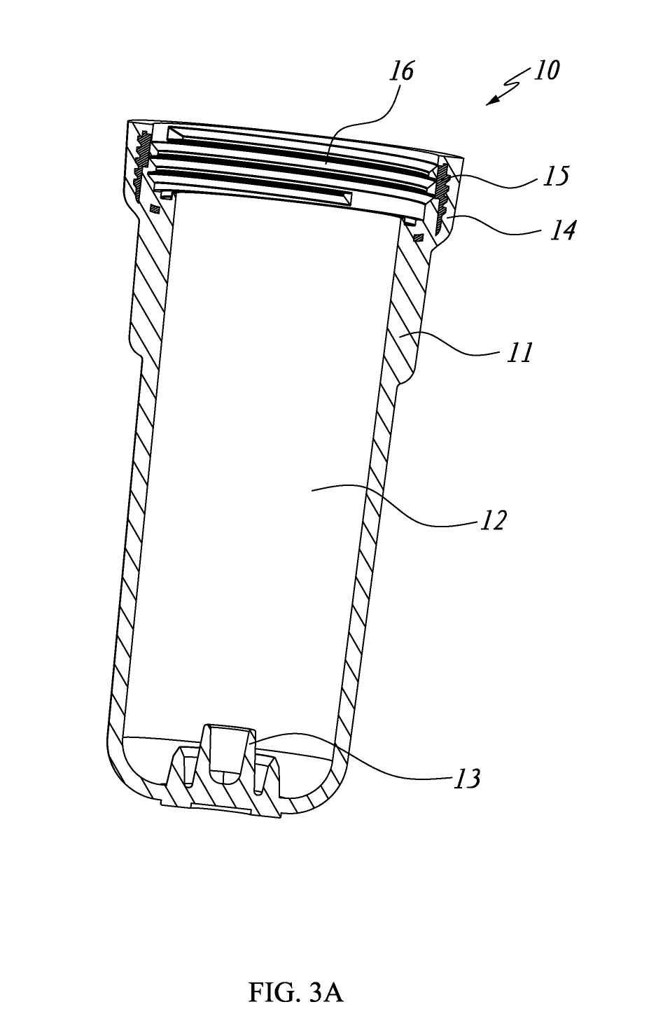

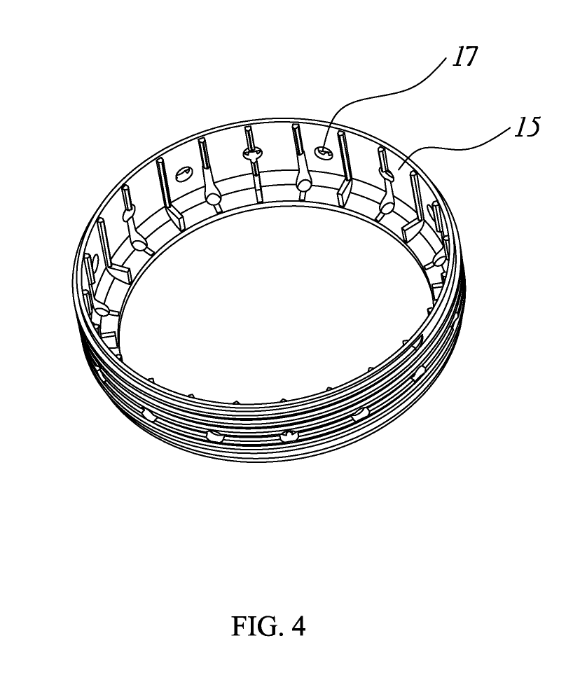

With reference to FIGS. 2 and 2A for schematic views of a filter cartridge structure of the present invention, the filter cartridge 10 is substantially the same as the conventional filter cartridge structure having a column-shaped main body 11 with an open top, a cavity 12 formed at the middle of the main body 11 and interconnected to the open top, a support base 13 disposed cavity 12 at the bottom of the main body 11 for installing a filter core (not shown in the figure), and a joint portion 14 formed at the open top of the main body 11 and coupled to a cylinder cover (not shown in the figure), wherein the joint portion 14 is slightly and outwardly extended along the main body and has an internal diameter slightly greater than the cavity 12. Particularly, an insert 15 is combined with the joint portion 14. The main body 11 of the filter cartridge of the present invention is integrally formed and made of AS, and the insert 15 is made of metal, ABS with a better tenacity, or any material with physical properties similar to those of the ABS, and the insert 15 is a ring with a thickness falling within a range of 2˜3 mm. In the molding process, the insert 15 is prepared and then integrally wrapped to form the main body 11 of the filter cartridge by molding injection, and the produced main body 11 is a two-layer structure as shown in FIG. 2A. The insert 15 is embedded into an inner side of the joint portion 14 of the main body 11, and an internal thread 16 is formed on an inner wall of the insert 15 and disposed corresponding to the cylinder cover to form a three-layer structure as shown in FIGS. 3 and 3A. In other words, the insert 15 is wrapped in the joint portion 14 of the main body 11, and this structure and the cylinder cover together with the internal thread 16 are arranged on the inner wall of the joint portion 14. To combine the insert 15 with the main body 11 more securely, a through hole 17 and a rib 18 are formed on the peripheral wall of the insert 15 as shown in FIG. 4.

With the aforementioned structure, the filter cartridge of the present invention is combined with the insert of a better tenacity and corresponding to the joint portion, so that the invention not only reduces the thickness of the wall of the filter cartridge, but also overcomes the stress problem of products manufactured by plastic injection molding. More importantly, the invention enhances the tenacity and the impact resisting strength of the joint portion of the filter cartridge and overcomes the fragility issue of the joint point of the conventional filter cartridge joint portion, so as to extend the service life of the filter product.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A filter cartridge structure comprising:
a column-shaped main body, having an open top and a first internal thread being formed on an inner wall of the open top, a cavity formed at the middle of the main body and interconnected to the open top, and a joint portion formed at the open top of main body, a second internal thread being formed on an inner wall of the joint portion, and a circular space being formed between the open top and the joint portion; and
an injection-molded insert formed in the circular space, having an outer thread formed on an outer wall of the insert to be engaged with the first internal thread.

2. The filter cartridge structure of claim 1, wherein the main body of the filter cartridge is integrally formed and made of Acrylonitrile-Styrene Copolymers (AS), and the insert is made of metal, Acrylonitrile-Butadiene-Styrene Terpolymer (ABS), or any material with physical properties similar to those of ABS.

3. (canceled)

4. (canceled)

5. The filter cartridge structure of claim 1, wherein the insert has a through hole formed on an inner peripheral wall of the insert.

6. The filter cartridge structure of claim 1, wherein the insert has a rib formed on an inner peripheral wall of the insert.
